(19) United States
(12) Patent Application Publication
(10) Pub. No.: US 2025/0380722 A1
(43) Pub. Date: Dec. 18, 2025

(54) Juice Concentrate Having a Reduced Sugar Content and Production Method

(71) Applicant: AUSTRIA JUICE GmbH, Allhartsberg (AT)

(72) Inventors: Thomas Holdenried, Amstetten (AT); Ulrich Zache, Münster-Sarmsheim (DE); Andreas Happe, Waldalgesheim (DE); Manfred Urban-Klik, Krems (AT)

(21) Appl. No.: 18/861,676

(22) PCT Filed: May 5, 2023
(86) PCT No.: PCT/EP2023/061972

§ 371 Date: Oct. 30, 2024

(30) Foreign Application Priority Data
May 5, 2022 (EP) 22171809.1

(51) Int. Cl. A23L 2/84; A23L 2/08; A23L 2/72; A23L 2/76

(52) U.S. Cl. CPC A23L 2/84; A23L 2/08; A23L 2/72; A23L 2/76

(57) ABSTRACT

The invention relates to a method for producing a juice concentrate having a reduced sugar content, in which method the sugar content of a juice is reduced by means of fermentation after the addition of microorganisms, and the ethanol produced by the fermentation is separated using additional fermentation products in an evaporator, as a result of which the juice concentrate having a reduced sugar content is obtained. The invention also relates to: a juice concentrate, preferably a fruit juice concentrate or vegetable juice concentrate, which can be obtained using said method; and a method for producing a juice having a reduced sugar content from said juice concentrate.

The field of the invention relates to methods for producing juice concentrates and juices having a reduced sugar content, as well as the juice concentrates and juices obtained therefrom.

Fruit juices, fruit wines and fruit brandies, as well as drinks made from these food products, have been produced for a very long time, sometimes for centuries and millennia. Fruit juices and production methods thereof are specified not only in the EU by directives and expert reports (AIJN Code of Practice-European Fruit Juice Association), but also in the WHO's international Codex Alimentarius. The natural composition of the ingredients of the fruit or the juice obtained therefrom, the established production methods thereof and the desired minimum dry matter content of the fruit juices usually result in a sugar content of the fruit juices of 5-20% w/w, depending on the fruit type.

Vegetable juices are also becoming more popular due to the increasing health awareness of consumers. It is this increasing health awareness that has also made reduced-sugar-content beverages fashionable.

Methods for reducing sugar content are known in the state of the art:

EP 2 404 508 A1 discloses a method for reducing the sugar content of fruit juices, wherein the alcohol produced by fermentation is removed by reverse osmosis. WO 2019/106564 A1 describes an adsorption-based method for reducing sugar content (e.g. on zeolite). U.S. Pat. No. 5,403,604 also addresses such methods.

EP 0 382 010 A1 and EP 055 488 A1 relate to methods for reducing the sugar content in fruit juices based on non-fermenting microorganisms that cannot form alcohol, such as Trichosporon brassicae, or based on method conditions that avoid alcoholic fermentation.

U.S. Pat. No. 4,971,813 A relates to a method for producing a concentrated fruit juice having a low-calorie content. Volatile aromas or flavours are separated in vacuo and collected. The non-volatile juice fraction is subjected to alcoholic fermentation with a yeast, and the alcohol formed thereby is distilled off. Finally, the volatile substances collected at the beginning are added to the juice fraction to obtain a beverage having a reduced calorie content.

Schwabl et al. (Mitteilungen Klosterneuburg 70 (2020): 102-114) address the development and sensory characterisation of a calorie-reduced apple juice-based beverage. That paper involved testing a method for producing a calorie-reduced apple juice-based beverage by means of fermentation. In the first step, the apple juice's aromas were evaporated and stored in a cool place. Subsequently, the aroma-free concentrate was fermented. Then, the alcohol and fermentation aromas were removed. A calorie-reduced apple juice drink was produced by blending the aroma-, alcohol- and sugar-free fraction with the original apple aroma preserved in the first treatment step, water and pasteurized apple juice having a natural sugar content.

Patent CH 632 137 A5 relates to a method for producing an alcohol-free fruit juice drink having a reduced calorie content and to the fruit juice drink produced according to this method. Sugar is broken down by microorganisms or enzymes, and the resulting breakdown products (e.g. alcohol) are then removed (e.g. by distillation).

U.S. patent application US 2016/0165944 A1 relates to a method for reducing the saccharide content in juice concentrates. In this method, the saccharide content is also reduced by alcoholic fermentation, but the alcohol is not distilled off, but rather-after the alcohol has been taken up in a gas stream-it is removed by adsorption (e.g. on zeolite). In that document, the removal of the alcohol by distillation is described as disadvantageous: the saccharide content of juices is much lower than that of juice concentrates, so this method is not suitable for concentrates as a starting material. Especially in the case of juice concentrates having a saccharide content of more than 20% w/v, often only part of the saccharides can be broken down, since the metabolisation of the microorganisms used for fermentation is greatly slowed down and often even inhibited by a rapidly increasing alcohol concentration. Furthermore, the distillation separation of the alcohol produced is particularly disadvantageous in this case, since the remaining saccharides enter into so-called Maillard reactions with amine compounds present in the concentrate even at low heats. Maillard reactions could lead to numerous undesirable compounds in the product. Moreover, it leads to an unpleasant dark colouration of the concentrate. These compounds also compromise the sensory properties of the concentrate, and the juice produced therefrom.

An object of the present invention is to provide an improved method for producing a juice concentrate having a sugar content reduced by means of fermentation. Disadvantages of methods of the prior art are to be overcome. In particular, this should enable the production of sugar-reduced juice concentrates or of sugar-reduced juices obtained from the juice concentrates, the sensory properties of which are as optimal as possible or as close as possible to original, non-sugar-reduced juices. Additionally, or alternatively, the methods or products according to the invention should be as smoothly applicable or usable on an industrial scale as possible or with as little effort as possible and/or be compatible with established processes in fruit or vegetable juice production.

Therefore, the present invention relates to a method for producing a juice concentrate having a reduced sugar content, comprising at least the following steps:
a) Providing juice having a Brix value A and a sugar content Z, wherein the juice is preferably a fruit juice or a vegetable juice;
b) De-aromatising the juice to obtain an aroma component and a de-aromatised juice;
c) Concentrating the de-aromatised juice to obtain a first juice concentrate, wherein the juice concentrate is preferably a fruit juice concentrate or a vegetable juice concentrate;
d) Re-diluting the first juice concentrate to a Brix value B, wherein the Brix value B is higher than the Brix value A and wherein the Brix value B is between 15° and 35°, preferably between 20° and 30°, whereby a second juice concentrate with a Brix value B is obtained, wherein the juice concentrate is preferably a fruit juice concentrate or a vegetable juice concentrate;
e) Adding microorganisms capable of alcoholic fermentation;
f) Fermenting the second juice concentrate under fermentation conditions that allow alcoholic fermentation, whereby a fermented product having an ethanol content of at least 6% v/v, preferably at least 8% v/v, in particular at least 10% v/v, is obtained; and
g) Separating ethanol and additional fermentation products from the fermented product in an evaporator, preferably a downflow evaporator, plate evaporator, thin-film evaporator or centrifugal evaporator, whereby the juice concentrate having a reduced sugar content is obtained, wherein the juice concentrate is preferably a fruit juice concentrate or a vegetable juice concentrate.

In a further aspect, the present invention relates to a method for producing a juice having a reduced sugar content, the juice preferably being a fruit juice or a vegetable juice, comprising at least the following steps:
Providing a juice concentrate having a reduced sugar content obtained by the method disclosed herein for producing a juice concentrate having a reduced sugar content; and
Diluting (e.g., with water) and mixing with a juice or another juice concentrate so that the juice having a reduced sugar content is obtained, the reduced sugar content being below the sugar content Z (as disclosed herein). Preferably, the reduced sugar content compared to the sugar content Z is 90% or less, 80% or less, 70% or less, 60% or less, 50% or less (i.e. 90% of Z or less, 80% of Z or less, 70% of Z or less, etc.).

Preferably, in the methods according to the invention, at least part of the previously separated aroma component is recycled (into the juice concentrate or the juice).

In yet another aspect, the present invention relates to a juice concentrate, preferably fruit juice concentrate or vegetable juice concentrate, which can be obtained by the method disclosed herein or a juice, preferably fruit juice or vegetable juice, which can be obtained by the method disclosed herein.

In another aspect, the present invention relates to a juice concentrate having a reduced sugar content, wherein the juice concentrate is selected from:

Apple juice concentrate having a sugar content of at most 17% w/w, preferably at most 14% w/w, in particular at most 11% w/w, a potassium content of at least 15,000 mg/kg, preferably at least 17,000 mg/kg, in particular at least 23,000 mg/kg, an acetic acid content of at most 1000 mg/kg or even at most 900 mg/kg, preferably at most 800 mg/kg, in particular at most 700 mg/kg (but usually at least 10 mg/kg), and preferably a glycerol content of at least 40 g/L, preferably at least 42 g/L, in particular at least 45 g/L, (but usually at most 65 g/L) and an orange juice concentrate having a sugar content of at most 17% w/w, preferably at most 14% w/w, in particular at most 118 w/w, a potassium content of at least 9500 mg/kg, preferably at least 12,000 mg/kg, in particular at least 15,000 mg/kg, an acetic acid content of at most 300 mg/kg or even at most 280 mg/kg, preferably at most 240 mg/kg, in particular at most 200 mg/kg, (but usually at least 10 mg/kg) and preferably a glycerol content of 16 g/L, at least 18 g/L, preferably at least 20 g/L, in particular at least 22 g/L (but usually at most 27 g/L).

In a last aspect, the present invention relates to a juice having a reduced sugar content, wherein the juice is selected from:
(varietal) apple juice having a sugar content of at most 81 g/L, preferably at most 72 g/L, in particular at most 63 g/L, a potassium content of 900-1500 mg/L, preferably 1000-1400 mg/L, in particular 1100-1300 mg/L, an acetic acid content of at most 400 mg/L, preferably at most 300 mg/L, in particular at most 200 mg/L, and preferably a glycerol content of at least 0.5 g/L, preferably at least 1.0 g/L, in particular at least 1.5 g/L or even at least 2.0 g/L,
(varietal) orange juice having a sugar content of at most 72 g/L, preferably at most 64 g/L, in particular at most 56 g/L, a potassium content of 1300-2500 mg/L, preferably 1500-2300 mg/L, in particular 1600-2200 mg/L, an acetic acid content of at most 400 mg/L, preferably at most 300 mg/L, in particular at most 200 mg/L, and preferably a glycerol content of at least 0.6 g/L, preferably at least 0.9 g/L, in particular at least 1.2 g/L,
(varietal) pineapple juice having a sugar content of at most 90 g/L, preferably at most 80 g/L, in particular at most 70 g/L, a potassium content of 900-2000 mg/L, preferably 1000-1900 mg/L, in particular 1100-1800 mg/L, an acetic acid content of at most 400 mg/L, preferably at most 300 mg/L, in particular at most 200 mg/L, and preferably a glycerol content of at least 0.5 g/L, preferably at least 1.0 g/L, in particular at least 1.5 g/L or even at least 2.0 g/L,
(varietal) banana juice having a sugar content of at most 145.8 g/L, preferably at most 129.6 g/L, in particular at most 113.4 g/L, a potassium content of 2900-4200 mg/L, preferably 3100-4000 mg/L, in particular 3300-3800 mg/L, an acetic acid content of at most 400 mg/L, preferably at most 300 mg/L, in particular at most 200 mg/L, and preferably a glycerol content of at least 0.5 g/L, preferably at least 1.0 g/L, in particular at least 1.5 g/L or even at least 2.0 g/L,
(varietal) pear juice having a sugar content of at most 78.3 g/L, preferably at most 69.6 g/L, in particular at most 60.9 g/L, a potassium content of 1000-2000 mg/L, preferably 1100-1900 mg/L, in particular 1200-1800 mg/L, an acetic acid content of at most 400 mg/L, preferably at most 300 mg/L, in particular at most 200 mg/L, and preferably a glycerol content of at least 0.5 g/L, preferably at least 1.0 g/L, in particular at least 1.5 g/L or even at least 2.0 g/L,
(varietal) kiwi juice having a sugar content of at most 68.4 g/L, preferably at most 60.8 g/L, in particular at most 53.2 g/L, a potassium content of 2500-4600 mg/L, preferably 2700-4400 mg/L, in particular 2900-4200 mg/L, an acetic acid content of at most 400 mg/L, preferably at most 300 mg/L, in particular at most 200 mg/L, and preferably a glycerol content of at least 0.5 g/L, preferably at least 1.0 g/L, in particular at least 1.5 g/L or even at least 2.0 g/L, and
(varietal) grape juice having a sugar content of at most 120.6 g/L, preferably at most 107.2 g/L, in particular at most 93.8 g/L, a potassium content of 900-2000 mg/L, preferably 1000-1900 mg/L, in particular 1100-1800 mg/L, an acetic acid content of at most 400 mg/L, preferably at most 300 mg/L, in particular at most 200 mg/L, and preferably a glycerol content of at least 0.5 g/L, preferably at least 1.0 g/L, in particular at least 1.5 g/L or even at least 2.0 g/L.

An advantage of the method according to the invention is that the first juice concentrate (cf. step c, above), due to its increased shelf life, represents an extremely suitable stopping point in the method that enables, for example, transport (e.g. to another unit) or storage. However, it has been found in the context of the invention that a re-dilution of this concentrate to a Brix value B between 15° and 35° (preferably between 20° and 30°; cf. step d) enables more effective fermentation (and ultimately leads to a better product from a sensory point of view). The higher alcohol content of the fermented product obtained in step f) in turn results in an extremely suitable stopping point in the method that enables, for example, transport (e.g. to another unit) or storage.

With the methods according to the invention disclosed herein, the products according to the invention disclosed herein can be produced for the first time, which, despite the reduced sugar content, have excellent sensory properties. The glycerol content achieved by the method according to the invention (also due to the slightly sweet taste of glycerol) also has a certain beneficial influence on the flavour profile, especially regarding mouthfeel.

The following detailed description relates to the methods and products (i.e. juices and juice concentrates) equally, e.g. preferred method features also correspond to properties or suitability of the products or their corresponding ingredients and preferred product features also correspond to agents used in the method according to the invention. All preferred features can be combined with each other unless explicitly excluded. All method features, including those mentioned above, can be combined with each other. All product features, including those mentioned above, can be combined with each other.

In the light of the present disclosure, it is obvious to the person skilled in the art that the order of the steps of the methods according to the invention (in particular steps a)-g) can be selected arbitrarily or steps can be carried out simultaneously, insofar as this is technically appropriate. For example, the order of steps d) and e) can be changed, or these steps can also be performed simultaneously. Additionally, or alternatively, steps b) and c), for example, can be performed simultaneously, e.g. in an evaporator suitable for this purpose. It is preferable to perform the steps in the alphabetical order a)-g), where necessary with simultaneous execution of successive steps, insofar as this is technically appropriate.

In step a) of the method for producing a juice concentrate having a reduced sugar content according to the invention, juice having a Brix value A and a sugar content Z is provided. This juice is preferably a fruit juice or a vegetable juice. In particular, the fruit juice is apple juice or orange juice, preferably with one of the following Brix values A and/or one of the following sugar contents Z:

| | Brix value A | sugar content Z |
|---|---|---|
| apple juice | ≥10.0° | ca. 10% w/w |
| (NFC/direct juice) | | |
| apple juice (from | ≥11.2° | ca. 10% w/w |
| apple juice | | |
| concentrate) | | |
| orange juice | ≥10.0° | ca. 8.0-8.5% w/w |
| (NFC/direct juice) | | |
| orange juice (from | ≥11.2° | ca. 8.0-8.5% w/w |
| orange juice | | |
| concentrate) | | |

In a preferred embodiment, the juice (in particular the fruit juice or vegetable juice) has a Brix value A of at least 5°, preferably at least 10°, or of 4°−30°, preferably of 10°-25°.

In another preferred embodiment, the juice is a fruit juice selected from apple juice, apricot juice, banana juice, currant juice, grape juice, grapefruit juice, guava juice, lemon juice, mango juice, orange juice, passion fruit juice, kiwi juice, peach juice, pear juice, pineapple juice, raspberry juice, sour cherry juice, strawberry juice, tomato juice, mandarin juice, and mixtures thereof, in particular selected from apple juice, pear juice and orange juice; or a vegetable juice selected from carrot juice, beetroot juice, and mixtures thereof; or a mixture of said fruit juice and said vegetable juice.

In steps b) and c) of the method for producing a juice concentrate having a reduced sugar content according to the invention, the juice is de-aromatised, and the de-aromatised juice is concentrated in order to obtain the first juice concentrate. These steps can also be performed simultaneously in suitable evaporators (in vacuo). It has proven advantageous for the further improvement of the storability of the first juice concentrate if the first juice concentrate has a Brix value of at least 40°, preferably at least 45°, more preferably at least 50°, even more preferably at least 55° or even at least 60°, in particular at least 65° or even at least 70°. Typically, a Brix value of 75° is not significantly exceeded.

Separating the aroma component has the advantage that the more sensitive flavours and aromas are not impaired by the fermentation or the further process steps (which would cause the flavour in the product to be lost or altered). However, it is obvious to the person skilled in the art that this de-aromatisation step cannot take place completely (i.e. so that no aromas or flavours at all remain in the de-aromatised juice). The aroma component can be composed of several fractions, which are stored (refrigerated) separately from each other.

In a preferred embodiment, the first juice concentrate has a water content of 25-40% w/w, preferably 30-35% w/w, for better storability.

For most optimal conditions for the subsequent fermentation, in step d) of the method for producing a juice concentrate having a reduced sugar content according to the invention, the first juice concentrate is re-diluted to a Brix value B, wherein the Brix value B is higher than the Brix value A and wherein the Brix value B is between 15° and 35°, preferably between 20° and 30°, whereby a second juice concentrate having the Brix value B is obtained. In the course of the present invention, this second juice concentrate has proven to be particularly suitable for the fermentative degradation of the sugar to the greatest possible extent, wherein at the same time in step g) a gentler separation of the ethanol is made possible, which in turn has a positive effect on the sensory properties of the end product.

In step e) of the method for producing a juice concentrate having a reduced sugar content according to the invention, microorganisms capable of alcoholic fermentation are added. In a preferred embodiment, the microorganisms comprise at least yeast of the genus Saccharomyces, preferably Saccharomyces cerevisiae, in particular Saccharomyces cerevisiae var. cerevisiae or Saccharomyces cerevisiae var. bayanus. It is particularly preferred to add (exclusively) selected yeasts in order to minimise the risk of by-products being formed during fermentation that cause an undesirable off-taste (off-flavour) in the end product.

Nutrients for the microorganisms are also expediently added in order to allow the fermentation to proceed as smoothly as possible. The term “nutrients” as used herein also includes minerals and vitamins. Phosphate salt (e.g., ammonium phosphate) and/or thiamine are particularly preferred as nutrients.

When adding the nutrients, it should be taken into account, as far as possible, that the flavour of the end product should not be altered, i.e. the amount added should preferably be as small as possible and still allow a smooth fermentation (i.e. a complete process of fermentation). In a preferred embodiment, only so much phosphate (salt) is added before the fermentation that the phosphate concentration in the fermented product after the removal of at least a part of the microorganisms is not more than 150%, preferably not more than 140%, more preferably not more than 130%, even more preferably not more than 120%, in particular not more than 110% or not more than 105% of the phosphate concentration in the second juice concentrate (obtained with step d).

In step f) of the method for producing a juice concentrate having a reduced sugar content according to the invention, the second juice concentrate is fermented under fermentation conditions that allow alcoholic fermentation. These fermentation conditions preferably comprise an fermentation temperature between 15° C. and 35° C., preferably 15° C. to 25° C., in particular between 20° C. and 25° C. Fermentation is preferably performed for 5-15 days.

An incubation under aeration (i.e. aerobic) is expediently carried out upstream in order to allow the subsequent fermentation to take place as smoothly as possible. Only then will step f) be performed, preferably continuously under anaerobic conditions.

Step f) gives a fermented product with an ethanol content of at least 6% v/v, preferably at least 8% v/v, in particular at least 10% v/v or even at least 12% v/v. Typically, an ethanol content of 17% v/v is not significantly exceeded.

After step f), at least some microorganisms are expediently removed, preferably followed by a filtration step for this purpose.

In a particularly preferred embodiment, a stabilising step (in particular between steps f) and g)) is performed. Stabilising agents or fining agents (such as bentonite, activated carbon, colloidal silica and/or proteins, for example, protein from peas or other legumes or potatoes) are added. This stabilising step is expediently followed by a filtration step (for removing the stabilising agents or fining agents).

In step g) of the method according to the invention for producing a juice concentrate having a reduced sugar content, ethanol and additional fermentation products (such as acetic acid, diacetyl, ethyl acetate, acetaldehyde, fruit esters and/or fusel oils; in particular acetic acid) are now separated from the fermented product in an evaporator. As a result, a juice concentrate having a reduced sugar content is obtained. Preferred parameters are, for example, 40-115° C. and negative pressure (0-900 mbar).

The resulting juice concentrate having a reduced sugar content preferably has a Brix value between 10° and 60°.

It is obvious to the person skilled in the art that this separation step cannot take place completely (i.e. so that no alcohol at all and no fermentation products at all remain in the juice concentrate). A certain, low alcohol content can be tolerated in fruit and vegetable juices.

The separation step (in the evaporator) should be as gentle as possible in order not to impair or falsify the sensory properties of the product. The excessive formation of hydroxymethylfurfural (HMF) should also be avoided, among other things, by exposure to heat. It is therefore preferred that the content of HMF in the obtained juice concentrate having a reduced sugar content be at most 50 mg/L, even more preferably at most 25 mg/L or even at most 20 mg/L, in particular at most 15 mg/L or even at most 10 mg/L (with regard to the dilution of the concentrate to single-strength). A certain content of HMF can sometimes not be completely avoided, so that the content of HMF in the juice concentrate having a reduced sugar content can be, for example, at least 0.5 mg/L or 1 mg/L (with regard to the dilution of the concentrate to single-strength).

Concomitantly, it is further preferred that the content of HMF in the (ultimately obtained) juice having a reduced sugar content be at most 50 mg/L, even more preferably at most 25 mg/L or even at most 20 mg/L, in particular at most 15 mg/L or even at most 10 mg/L. A certain content of HMF can sometimes not be completely avoided, so that the content of HMF in the juice having a reduced sugar content can be, for example, at least 0.5 mg/L or 1 mg/L.

According to another preferred embodiment, the content of hydroxymethylfurfural in the juice concentrate having a reduced sugar content is at most 1000 mg/L, preferably at most 750 mg/L, more preferably at most 500 mg/L, even more preferably at most 250 mg/L or even at most 200 mg/L, in particular at most 150 mg/L or even at most 100 mg/L. A certain content of HMF can sometimes not be completely avoided, so that the content of HMF in the juice concentrate having a reduced sugar content can be, for example, at least 5 mg/L or at least 10 mg/L.

Suitable evaporators are known to the person skilled in the art in the light of this description. Suitable evaporators are disclosed, for example, in Cyklis 2022 (Journal of Food Engineering 317 (2022): 110884.), Adnan & Mushtaq 2018 (in: Fruit Juices. Academic Press, 2018. 217-240.) and U.S. Pat. No. 4,971,813 A.

The evaporators used are preferably downflow evaporators, plate evaporators, thin-film evaporators or centrifugal evaporators.

In a preferred embodiment, the evaporator is equipped with a vacuum pump to additionally generate negative pressure.

In another preferred embodiment, the separation of ethanol in step g) takes place in a multistage evaporator with a stepwise lowering of the temperature. As a result, the process is as gentle as possible, and the sensory properties of the end product are improved.

In another preferred embodiment, after step g), a (further) stabilising step is performed in order to further reduce any undesirable fermentation aromas still present. Stabilising agents or fining agents (such as bentonite, activated carbon, colloidal silica and/or proteins, for example protein from peas or other legumes or potatoes) are added. This stabilising step is expediently followed by a filtration step (for removing the stabilising agents or fining agents).

In another preferred embodiment, the juice concentrate having a reduced sugar content is fruit juice concentrate selected from apple juice concentrate, apricot juice concentrate, banana juice concentrate, currant juice concentrate, grape juice concentrate, grapefruit juice concentrate, guava juice concentrate, lemon juice concentrate, mango juice concentrate, orange juice concentrate, passion fruit juice concentrate, peach juice concentrate, pear juice concentrate, kiwi juice concentrate, pineapple juice concentrate, raspberry juice concentrate, sour cherry juice concentrate, strawberry juice concentrate, tomato juice concentrate, mandarin juice concentrate, and mixtures thereof, particularly selected from apple juice concentrate, pear juice concentrate, and orange juice concentrate; or a vegetable juice concentrate selected from carrot juice concentrate, beetroot juice concentrate, and mixtures thereof; or a mixture of said fruit juice concentrate and said vegetable juice concentrate.

In a further, preferred embodiment, the method additionally comprises a step h): h) blending the juice concentrate having a reduced sugar content with a further juice concentrate, so that a sugar content of 5% to 90% of the sugar content Z is achieved. Preferably, at least part of the previously separated aroma component is recycled beforehand or in the process. The juice concentrate thus obtained can be used in various foods and beverages that have a certain juice content, but with a noticeable sugar reduction compared to foods and beverages based on whole sugar juices (e.g. for mixed drinks, juice drinks and fruit juice drinks).

It has been found that the method according to the invention can be used to produce juices that contain succinic acid that advantageously influences the sensory properties. Therefore, in a preferred embodiment, the content of succinic acid in the juice concentrate having a reduced sugar content or in the juice (ultimately obtained) is at least 20 mg/L, preferably at least 40 mg/L, more preferably at least 60 mg/L, even more preferably at least 70 mg/L or even at least 80 mg/L, in particular at least 90 mg/L or even at least 100 mg/L. Preferably, however, the juice does not contain more than, e.g., 1000 mg/L or 500 mg/L succinic acid.

It has also been found that the method according to the invention can be used to prepare juices, which contain propylene glycol that advantageously influences the sensory properties. Therefore, in a preferred embodiment, the content of propylene glycol in the juice concentrate having a reduced sugar content or in the juice (ultimately obtained) is at least 10 mg/L, preferably at least 20 mg/L, more preferably at least 30 mg/L, even more preferably at least 40 mg/L or even at least 50 mg/L, in particular at least 60 mg/L or even at least 70 mg/L. Preferably, however, not more than e.g. 1000 mg/L or 500 mg/L or 250 mg/L propylene glycol are contained in the juice.

The Brix value (′Brix) refers to a unit that indicates the content of soluble solids in a solution. One degree Brix equals to 1 gram of sucrose in 100 grams of sucrose/water solution and thus represents the concentration of soluble solids in the solution in percent by weight (% w/w). A solution has a Brix value of 1° if the density of this solution is the same as that of a solution of 1 gram of sucrose in 100 grams of sucrose/water solution (at 20° C. and normal pressure). The Brix value is usually measured with a refractometer.

The invention is explained in more detail below with reference to preferred, non-limiting examples and drawings.

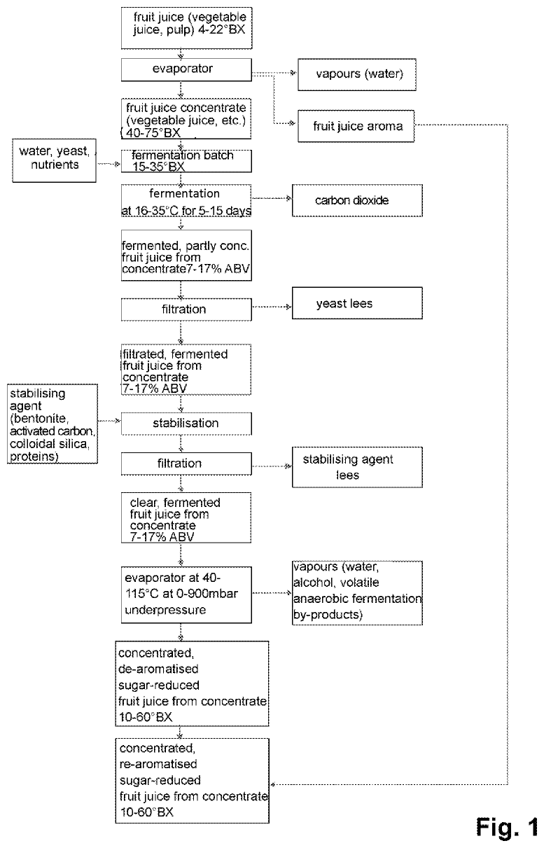

FIG. 1 shows an embodiment of the method for producing juice concentrate having a reduced sugar content according to the invention. Abbreviations: BX—Brix, ABV—Ethanol content (% v/v).

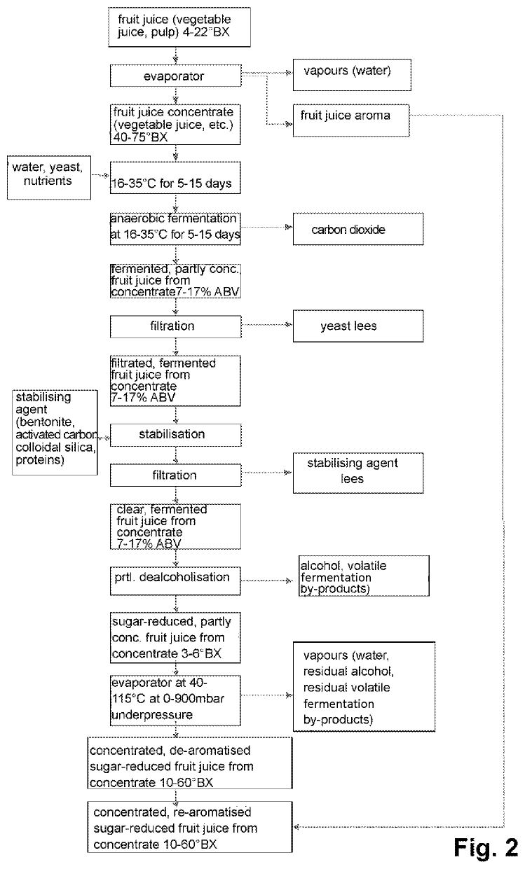

FIG. 2 shows another embodiment of this method. Abbreviations: BX—Brix, ABV—ethanol content (% v/v); prtl.—partial.

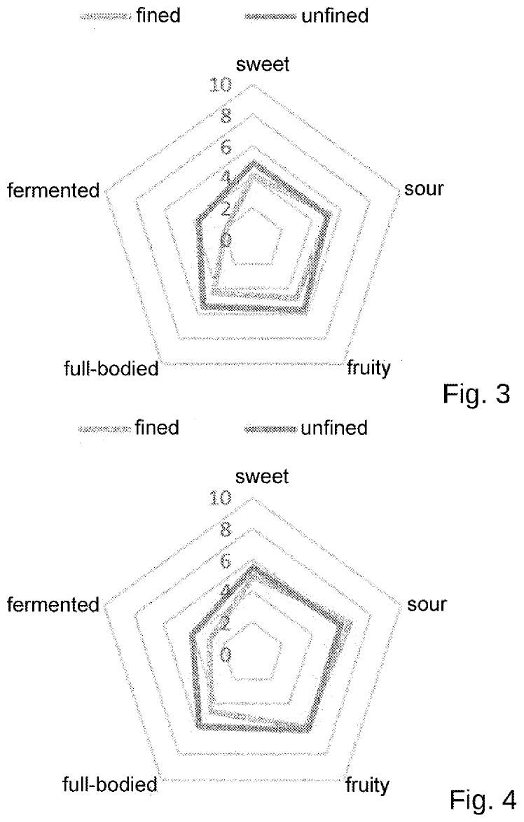

FIG. 3 shows the results of a tasting of sugar-reduced orange juices according to the invention, which have been produced without or with a stabilising step (with activated carbon as a fining agent) after step g), in the form of a radar chart.

FIG. 4 shows the results of a tasting of apple juices according to the invention, which have been produced without or with a stabilising step (with activated carbon as a fining agent) after step g), in the form of a radar chart.

### EXAMPLE 1

An embodiment of the method for producing a juice concentrate having a reduced sugar content according to the invention is shown in FIG. 1. A fruit juice (e.g., apple or orange juice), or optionally a vegetable juice or a pulp, having a Brix value between 4° and 22° and a sugar content Z is concentrated in an evaporator (e.g., in a downflow evaporator) to form a concentrate (i.e. a fruit juice concentrate or a vegetable juice concentrate). This separated juice aroma (i.e. fruit juice aroma or vegetable juice aroma) is reintroduced later in the process. Thereafter, microorganisms (e.g., Saccharomyces cerevisiae var. bayanus), nutrients for the microorganisms and water (for re-dilution) are supplied in order to obtain a fermentation batch with a Brix value of 15° to 35°. Fermentation is performed at 16-35° C. for 5-15 days to obtain a fermented juice with 7-17% v/v ethanol. The filtrate is stabilised with stabilising agents such as bentonite, activated carbon, colloidal silica and/or proteins (e.g., protein from peas or other legumes or potatoes) and filtered again. The alcohol is separated from the filtrate obtained therefrom (clear, fermented fruit or vegetable juice with 7-17% v/v ethanol) in an evaporator (e.g. a downflow evaporator, plate evaporator, thin-film evaporator or centrifugal evaporator) at 40-115° C. and under negative pressure. Finally, the previously separated aroma component is added to the dealcoholised concentrate (Brix value 10° to) 60°. This juice concentrate having a reduced sugar content is now back-blended with non-sugar-reduced juice concentrate and water to drinking strength in the desired ratio, so that a specific sugar reduction of 10% to 95% is achieved compared to the sugar content Z.

Alternatively, the juice concentrate having a reduced sugar content is blended with non-sugar-reduced juice concentrate in the desired ratio in order to achieve a certain sugar reduction of 10% to 95%. This sugar-reduced juice can be used in various foods and beverages that have a certain juice content, but with a noticeable sugar reduction compared to foods and beverages based on whole sugar juices (e.g., for mixed drinks, juice drinks and fruit juice drinks).

### EXAMPLE 2

Another embodiment of the method for producing a juice concentrate having a reduced sugar content according to the invention is shown in FIG. 2. Here, the procedure is as in Example 1, but the separation of the alcohol (ethanol) takes place in two steps. First, alcohol and volatile fermentation by-products (e.g., by distillation) are separated in a first unit without significant water loss (“prtl. dealcoholisation”), then the partially dealcoholised product obtained therefrom (Brix value 3°-6°) is introduced into a second unit (in this case: evaporator) in order to separate residual alcohol and water and to obtain a juice concentrate having a reduced sugar content.

### EXAMPLE 3

An empirical analysis was performed to further investigate the sensory advantages of the method according to the invention. Furthermore, the influence of the activated carbon fining of the already dealcoholised juice concentrate having a reduced sugar content on any fermentation by-products that may still be present was investigated. To this end, a comparison tasting was performed by a panel.

### Preparation of Juice Concentrates Having a Reduced Sugar Content:

By means of the method according to the invention (performing steps a)-g)), an orange juice concentrate having a reduced sugar content and an apple juice concentrate having a reduced sugar content were prepared (sugar reduction by 90% compared to the original sugar content z).

### Stabilisation:

In each case, part of the juice concentrate having a reduced sugar content was fined with activated carbon, while another part remained unfined for comparison. Details are given in Table 1:

TABLE 1

| | | | | Dosage at | |
|---|---|---|---|---|---|
| | | | Brix of | single- | Single- |
| Concen- | Activated | Dosage | concentrate | strength | strength |
| trate | carbon | [g/L] | [°Bx] | [g/L] | [°Bx] |
| Orange | Carbopal | 90 | 50 | 6 | 3.5 |
| | MC-P | | | | |
| Apple | Ercarbon | 26 | 60 | 1 | 2.3 |
| | SH | | | | |

After one hour of exposure time, the activated carbon has been removed by diatomaceous earth and layer filtration.

### Back-Blending to Drinking Strength:

In order to obtain 30% sugar-reduced fruit juice drinks, the juice concentrates having a reduced sugar content were correspondingly mixed with conventional fruit juice concentrate and mixed with aromas and water.

Four different drinking samples were prepared, two orange drinks (“fined” or “unfined”) and two apple drinks (“fined” or “unfined”). The respective formulas are given in Table 2.

TABLE 2

| | | | Sugar | Brix |
|---|---|---|---|---|
| Sample | Description | Ingredient | [g/L] | [°Bx] |
| 1 | Orange | Orange juice concentrate | 116.7 | 65 |
| | fined | (sweet) | | |
| | | Juice concentrate having | 43.4 | 28 |
| | | a reduced sugar content | | |
| | | (fined) | | |
| | | Oranges add-back | 0.2 | |
| | | Orange oil | 0.2 | |
| | | Water | | |
| 2 | Orange | Orange juice concentrate | 116.7 | 65 |
| | unfined | (sweet) | | |
| | | Juice concentrate having | 43.4 | 28 |
| | | a reduced sugar content | | |
| | | (unfined) | | |
| | | Oranges add-back | 0.2 | |
| | | Orange oil | 0.2 | |
| | | Water | | |
| 3 | Apple | Apple juice concentrate | 111.55 | 67.92 |
| | fined | 70°Bx | | |
| | | Juice concentrate having | 15.52 | 32.21 |
| | | a reduced sugar content | | |
| | | (fined) | | |
| | | Apple aroma (half | 0.65 | |
| | | concentrate) | | |
| | | Water | | |
| 4 | Apple | Apple juice concentrate | 111.55 | 67.92 |
| | unfined | 70°Bx | | |
| | | Juice concentrate having | 15.52 | 32.21 |
| | | a reduced sugar content | | |
| | | (unfined) | | |
| | | Apple aroma (half | 0.65 | |
| | | concentrate) | | |
| | | Water | | |

The samples (sugar reduction: 30%) produced for the tasting had the physical/chemical parameters indicated in Table 3.

TABLE 3

| | | | Titratable | | |
|---|---|---|---|---|---|
| | | | acidity (as | | |
| | | | citric acid) | Carbohy- | Of which |
| | | | at pH 8.1 in | drates | sugar |
| Sample | Description | °Brix | g/L | [g/L] | [g/L] |
| 1 | Orange fined | 8.5 | 6.8 | 62 | 61 |
| 2 | Orange unfined | 8.5 | 6.8 | 62 | 61 |
| 3 | Apple fined | 8.3 | 3.7 | 71 | 65 |
| 4 | Apple unfined | 8.3 | 3.7 | 71 | 65 |

For comparison, the typical physical/chemical parameters of a 100% fruit juice without sugar reduction are given in Table 4.

TABLE 4

| | | Titratable | | |
|---|---|---|---|---|
| | | acidity (as | | |
| | | citric acid) | | Of which |
| | | at pH 8.1 in | Carbohydrates | sugar |
| Description | °Brix | g/L | [g/L] | [g/L] |
| Orange juice 100% | 11.2 | 8.2 | 89 | 89 |
| Apple juice 100% | 11.2 | 4.8 | 110 | 100 |

### Tasting:

Samples 1-4 were evaluated by 11 panellists according to the following attributes: sweet, sour, fruity, full-bodied and fermented, each on a scale from 0 (not perceptible at all) to 10 (very strongly perceptible).

The respective mean values of the attributes are shown in FIGS. 3 (orange drinks: samples 1 and 2) and 4 (apple drinks: samples 3 and 4) in radar charts.

Overall, all four samples met the sensory requirements, having the fined samples 1 and 3 each a lower fermentation note. It follows that the fining advantageously contributes to the reduction of undesirable fermentation notes without unduly influencing the other attributes.

In detail, it can be seen in FIG. 3 that the fermentation note greatly decreased and was almost no longer perceptible due to the fining of the orange juice concentrate having a reduced sugar content. Palatefulness (full-bodiedness), sweetness and fruitiness were also reduced by the activated carbon treatment, but to a rather small extent, while the acidity remained constant.

In detail, it can be seen in FIG. 4 that the fermentation note has been reduced by about half as a result of the fining. The intensity of the palatefulness also decreased somewhat. Compared to the sugar-reduced orange drink, the fermented taste of the apple drink decreased slightly less due to the activated carbon fining, but the sensation of fruitiness, sweetness and acidity is also less strongly influenced.

1. A method for producing a juice concentrate having a reduced sugar content, comprising at least the following steps:
a) Providing juice having a Brix value A and a sugar content Z;
b) De-aromatising the juice to obtain an aroma component and a de-aromatised juice;
c) Concentrating the de-aromatised juice to obtain a first juice concentrate having a Brix value of at least 40°;
d) Re-diluting the first juice concentrate to a Brix value B, wherein the Brix value B is higher than the Brix value A and wherein the Brix value B is between 15° and 35°, whereby a second juice concentrate with a Brix value B is obtained;
e) Adding microorganisms capable of alcoholic fermentation;
f) Fermenting the second juice concentrate under fermentation conditions that allow alcoholic fermentation, whereby a fermented product having an ethanol content of at least 6% v/v is obtained; and
g) Separating ethanol and additional fermentation products from the fermented product in an evaporator, whereby the juice concentrate having a reduced sugar content is obtained.

2. The method of claim 1, further comprising
Diluting and mixing the juice concentrate having a reduced sugar content with a juice or another juice concentrate so that a juice having a reduced sugar content is obtained, wherein the reduced sugar content is below the sugar content Z.

3. The method of claim 1, wherein the additional fermentation products in step g) are selected from the group consisting of acetic acid, diacetyl, ethyl acetate, acetaldehyde, fruit esters, and fusel oils.

4. The method of claim 1, wherein the separation of ethanol in step g) is carried out in a multistage evaporator with a stepwise lowering of the temperature.

5. The method of claim 1, wherein the fermentation conditions in step f) comprise a fermentation temperature between 15° C. and 35° C.

6. The method of claim 1, wherein the microorganisms in step e) comprise at least yeast of the genus Saccharomyces.

7. The method of claim 1, wherein after step f) at least a part of the microorganisms is removed.

8. The method of claim 1, wherein stabilising agents such as bentonite, activated carbon, colloidal silica and/or proteins are added before and/or after step g).

9. The method of claim 1, wherein the first juice concentrate has a water content of 25-40% w/w.

10. The method of claim 1, wherein the juice concentrate having a reduced sugar content is a fruit juice concentrate, selected from apple juice concentrate, apricot juice concentrate, banana juice concentrate, currant juice concentrate, grape juice concentrate, grapefruit juice concentrate, guava juice concentrate, lemon juice concentrate, mango juice concentrate, orange juice concentrate, passion fruit juice concentrate, peach juice concentrate, pear juice concentrate, kiwi juice concentrate, pineapple juice concentrate, raspberry juice concentrate, sour cherry juice concentrate, strawberry juice concentrate, tomato juice concentrate, mandarin juice concentrate, and mixtures thereof; or wherein the juice concentrate having a reduced sugar content is a vegetable juice concentrate selected from carrot juice concentrate, beetroot juice concentrate, and mixtures thereof; or wherein the juice concentrate is a mixture of said fruit juice concentrate and said vegetable juice concentrate.

11. The method of claim 1, wherein the juice is a fruit juice selected from apple juice, apricot juice, banana juice, currant juice, grape juice, grapefruit juice, guava juice, lemon juice, mango juice, orange juice, passion fruit juice, kiwi juice, peach juice, pear juice, pineapple juice, raspberry juice, sour cherry juice, strawberry juice, tomato juice, mandarin juice, and mixtures thereof; or wherein the juice is a vegetable juice selected from carrot juice, beetroot juice, and mixtures thereof; or wherein the juice is a mixture of said fruit juice and said vegetable juice.

12. A juice concentrate obtained by the method of claim 1, wherein the content of hydroxymethylfurfural in the juice concentrate is at most 1000 mg/L.

13. A juice obtained by the method of claim 2, wherein the content of hydroxymethylfurfural in the juice is at most 50 mg/L.

14. (canceled)

15. (canceled)

16. (canceled)

17. The juice concentrate of claim 12, wherein the content of propylene glycol in the juice concentrate is at least 100 mg/L.

18. The juice concentrate of claim 12, the wherein the content of succinic acid in the juice concentrate is at least 20 mg/L.

19. (canceled)

20. The juice of claim 13, wherein the content of propylene glycol in the juice is at least 10 mg/L.

21. The juice of claim 13, wherein the content of succinic acid in the juice is at least 20 mg/L.
